(19) United States
(12) Patent Application Publication
(10) Pub. No.: US 2012/0246636 A1
(43) Pub. Date: Sep. 27, 2012

(54) METHOD AND ARRANGEMENT FOR INSTALLING AND CONFIGURING A COMPUTER SYSTEM

(75) Inventors: Christian STICH, Hirschberg-Leutershausen (DE); Marcel Dix, Mannheim (DE); Mikael Rudin, Vasteras (SE); Sylvia Maczey, Hirschberg (DE)

(73) Assignee: ABB TECHNOLOGY AG, Zurich (CH)

(21) Appl. No.: 13/434,058

(22) Filed: Mar. 29, 2012

Related U.S. Application Data
(63) Continuation of application No. PCT/EP2010/005842, filed on Sep. 24, 2010.

(30) Foreign Application Priority Data
Sep. 29, 2009 (DE) 10 2009 043 287.6

(51) Int. Cl. G06F 9/445

(52) U.S. Cl. 717/176; 717/174

(57) ABSTRACT

Exemplary systems and methods for installing and configuring a computer include stipulating configuration rules and transmitting all programs to be installed to the memories of the computers of the computer system, selecting and executing functions which are intended to be executed by the computer system, in a sequence, and checking to determine whether a running function which is currently being executed contravenes a configuration rule.

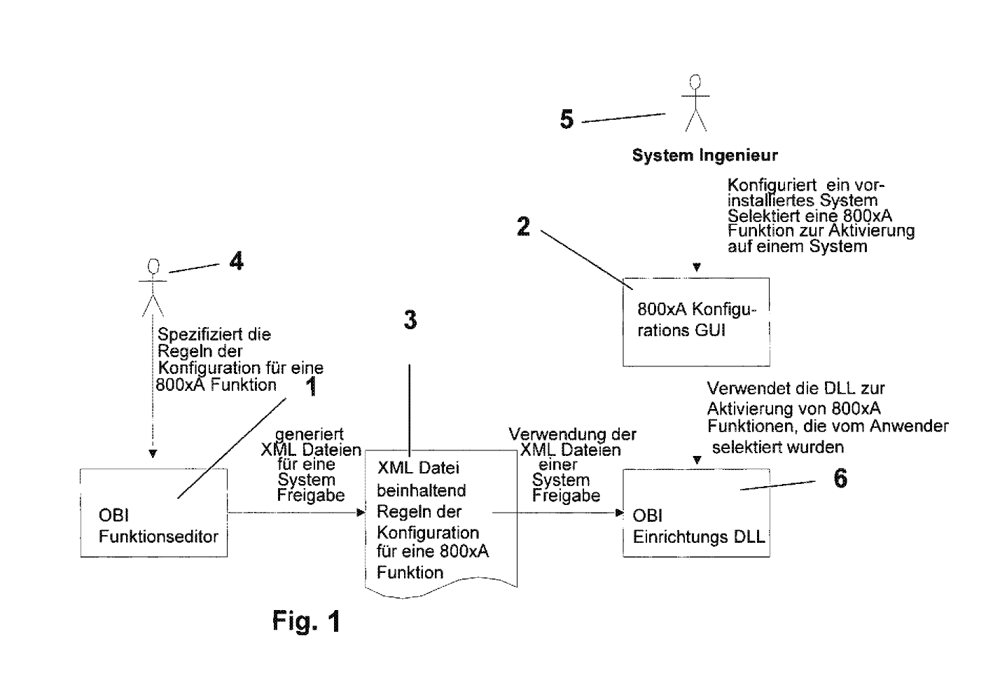

### RELATED APPLICATION(S)

This application is a continuation under 35 U.S.C. §120 of International Application No. PCT/EP2010/005842 filed on Sep. 24, 2010, which claims priority to German Application No. 10 2009 043 287.6 filed in Germany on Sep. 29, 2009, the content of which is hereby incorporated by reference in their entirety.

### FIELD

The present disclosure relates to a computer system, such as a method and system for installing and configuring a computer system.

### BACKGROUND INFORMATION

Currently, known distributed or networked computer system having programs or program packages running on it are planned and configured. The programs or program packages are installed on the computers of the computer system and the programs or program packages are then reconfigured.

Installing a distributed or networked environment or a distributed or networked computer system, in particular a distributed control system, can be one of the greatest difficulties for a commissioning engineer.

This is because detailed knowledge of the possible variables for installing and configuring a computer system should be specified for this purpose, with the result that only selected experts can install a computer system in such a manner that it is in a state suitable for operation.

In this case, there is the difficulty, in particular, of knowing all dependencies and restrictions or constraints of different programs or program packages and their versions which are distributed over the entire computer system.

Against this background, the production or execution of a function means the activation and interaction of programs or program packages comprising (e.g., consisting of) individual components on different computers. Combining programs or program packages running on different computers of a network makes it possible to execute a function.

However, extremely comprehensive knowledge of the entire computer system, in addition to programs or program packages, should be obtained in this case to activate the different programs or program packages on the correct computers in the correct order in advance and to configure them for the specified function in a distributed environment. The planning phase for installing and configuring a computer system is therefore often extremely tedious. Therefore, there is a need of the users for a computer system which can be easily installed and easily managed. In particular, the difficulties at the beginning of the installation process are intended to be minimized in this case.

### SUMMARY

An exemplary method for installing and configuring a computer system is disclosed, comprising the steps of: stipulating configuration rules and transmitting all programs to be installed to memories of computers of the computer system, selecting and executing functions which are intended to be executed by the computer system, in a sequence; and checking to determine whether a running function which is currently being executed contravenes a configuration rule.

An exemplary system for installing and configuring a computer system is disclosed, comprising: a network of computers; and an apparatus which includes a memory device and hardware, the memory device storing software which controls the hardware in such a manner that the hardware at least one of selects and executes functions for running on one or more of the computers in a sequence, and checks whether a function which has been at least one of selected and a running function currently being executed contravene a configuration rule.

### BRIEF DESCRIPTION OF THE DRAWINGS

The FIGURE is a schematic illustration of a diagram for carrying out the method for installing and configuring a computer system.

### DETAILED DESCRIPTION

Exemplary embodiments of the present disclosure specify a method and an apparatus for carrying out installation and configuration steps without any problems and in a transparent and reliable manner.

An exemplary method of the present disclosure provides functions which are intended to be executed by the computer system, such as a distributed computer system, are selected and executed, for example in a sequence, in which case a check is carried out to determine whether a function which is currently being executed and/or running contravenes a configuration rule.

The exemplary method advantageously provides no need for the respective functions to be selected in a particular sequence, rather two, three or more functions could also be selected, for example, at once or in a parallel manner (e.g., without a sequence or order) instead of being selected one after the other or in sequence.

According to the present disclosure, it was first recognized that there is a need for a bottom-up approach in order to provide the commissioning engineers with an easily comprehensible, transparent installation process. It was also recognized that there should be a capability to configure the computer system after the installation process in order to activate the easily installed computer system. It was recognized in the context of the exemplary embodiments disclosed herein that a planning phase before the installation and configuration processes can be considerably shortened. Exemplary embodiments disclosed herein therefore specify a general approach for setting up distributed computer systems. This exemplary approach includes the principle of enabling concurrent, simultaneous and undelayed configuration on each computer of a distributed computer system. As soon as a function is executed, a test is simultaneously carried out in order to determine whether this function contravenes a configuration rule. This makes it possible to easily detect and rectify faults during installation. In particular, it was recognized that, by checking each individual specified function, it becomes transparent which function contravenes a configuration rule. In this respect, an exemplary method which can be used to carry out installation and configuration steps without any problems and in a transparent and reliable manner is specified.

In exemplary embodiments of the present disclosure all programs are advantageously transmitted to all memories of the computers without first of all starting these programs. This ensures that each function can be activated individually and in succession. Difficulties at the beginning of the installation process are effectively avoided in this case.

After transmission to the computers, the services of each function of the distributed computer system are activated by activating or deactivating the functions on different computers. This makes it possible to determine which services are assigned to which functions. A function is produced or executed by combining programs running on different computers of a network. In this case, individual components of programs on different computers are activated and interact with one another. The programs which are needed to execute a function can be detected without any problems.

In order to check whether a function which has been selected, and in particular is intended for execution, and/or a running function currently being executed contravene(s) a configuration rule, a dependency and constraint solver is advantageously used. This means that no expert is authorized to install and configure the computer system. The dependency and constraint solver provides a core function which follows and complies with all dependencies and constraints or restrictions. The execution of functions is restricted by the configuration rules. The configuration rules stipulate dependencies and restrictions or constraints. Configuration rules which are given by dependencies between the different programs and their running services must be calculated. Use is therefore made of the dependency and constraint solver which can interpret the configuration rules and can verify which function is allowed on which computer in the distributed system. A check of the compilation of the services is particularly important here.

The dependency and constraint solver dynamically examines the configuration rules and determines, after or during selection of a function intended for execution and/or during the course of a function, whether the respective function, in particular the currently running function, is allowed to be executed. The fundamental idea of the method described here for the rule-based installation and configuration of a distributed computer system is based on simplifying configurations of a distributed system and reducing the number of predetermined settings of the computer system. For this purpose, all programs can be transmitted to all computers and only those programs which are needed for a particular function are then activated. It is advantageous in this case that all computers of the system are configured in a similar manner from a program installation perspective. In addition, the person cannot enter any errors into the computer system during installation. Therefore, the installation process can be carried out in a simpler and faster manner.

In exemplary embodiments disclosed herein, the functions are advantageously presented on a display or in a protocol together with the services and sequences assigned to them. In this case, a snapshot of the functions on each node or computer of the distributed computer system is given by the services and sequences running on said node or computer. In this respect, the user can be presented with any function on any computer and in the distributed computer system by detecting one or more services and sequences belonging to the functions.

Use is advantageously made of a data module which stores and assesses the configuration rules. The data module which uses, in particular, the XML format stores and assesses the configuration rules in files. The permissibility of functions can be restricted by configuration rules. Dependencies and restrictions or constraints prescribe the configuration rules for different running functions in a distributed environment on the different nodes or computers. This allows the permissibility of the compilation of the running services to be checked.

In this case, provision can advantageously be made for not only the rules of the programs which have already been executed, in particular the associated functions and/or services, to be checked but also for those rules which indicate whether a selected program, in particular the associated functions and/or services, is allowed to be executed and/or started to be checked.

Exemplary embodiments of the present disclosure can include a function editor. The function editor is a tool which allows one or more functions to be selected and determined for a particular computer system. The function editor also collects and/or presents sequences and services which have to be started in order to activate a particular function in the computer system. The function editor writes all information, in particular configuration rules, input for a function, to a file.

The objectives and advantages already mentioned at the outset achieved by an exemplary arrangement for installing and configuring a computer system, which arrangement (e.g., system) comprises (e.g., consists of) a network of computers and an apparatus, the apparatus including a memory device and hardware, and the memory device storing software which controls the hardware in such a manner that the latter selects functions for running on one or more of the computers in a sequence, executes said functions and checks whether a running function which is currently being executed contravenes a configuration rule.

The arrangement advantageously carries out all method steps of the method described here individually or in combination. For this purpose, the hardware of the apparatus advantageously comprises a function editor and a dependency and constraint solver.

The single FIGURE schematically shows a method for installing and configuring a distributed or networked computer system using a diagram in accordance with an exemplary embodiment of the present disclosure.

The exemplary method disclosed herein for the rule-based installation and configuration of a distributed or networked computer system is based on a system that includes two components, a function editor 1 and a dependency and constraint solver 2 for configuration.

The function editor 1 is a tool which allows one or more functions of a particular computer system to be selected and determined. The function editor 1 also collects and/or presents sequences and services which have to be started in order to activate a particular function in the computer system. The function editor 1 writes all information, in particular configuration rules, input for a function, to a file 3.

A distributed or networked computer system is set up by the dependency and constraint solver 2 by activating functions.

Configuration rules are interpreted during the simultaneous setting-up of each function in order to determine whether or not the selected function is allowed to be activated in the computer system or on a computer of the computer system.

A configuration rule determines, for example, that a function A must not be installed together with a function B on the same computer or that a function C must not occur more than three times in a distributed computer system.

If a function is allowed to be activated, the dependency and constraint solver 2 can activate said function by executing the services and/or specified sequences or executables corresponding to the function.

An exemplary method of the present disclosure can be carried out as follows:

A person 4 stipulates the configuration rules. The function editor 1 can be used for this purpose. The function editor 1 is used to collect the configuration rules and to generate files 3 in the XML format. The files 3 in the XML format store the configuration rules.

The commissioning engineer 5 selects a function which is intended to be activated. The dependency and constraint solver 2 sets up the distributed or networked computer system by activating the function. In this case, the dependency and constraint solver 2 interprets the configuration rules during the simultaneous setting-up of each function in order to determine whether or not the selected function is allowed to be activated in the computer system or on a computer of the computer system. For this purpose, it uses a dynamic library (dynamic link library) 6 which accesses the files 3.

With regard to further advantageous refinements and developments of the teaching according to the disclosure, reference is made, on the one hand, to the general part of the description and, on the other hand, to the patent claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Function editor
2 Dependency and constraint solver
3 File
4 Person
5 Commissioning engineer
6 Dynamic library (dynamic link library)

What is claimed is:

1. A method for installing and configuring a computer system, comprising the steps of:
stipulating configuration rules and transmitting all programs to be installed to memories of computers of the computer system,
selecting and executing functions which are intended to be executed by the computer system, in a sequence; and
checking to determine whether a running function which is currently being executed contravenes a configuration rule.

2. The method as claimed in claim 1, comprising:
transmitting programs to memories of the computers of the computer system without first of all starting them.

3. The method as claimed in claim 2, comprising:
activating services of each function after the programs have been transmitted to the computers, by activating or deactivating the functions on different computers.

4. The method as claimed in claim 1, comprising:
using a dependency and constraint solver to check whether at least one of a function which has been of selected and a running function currently being executed contravene a configuration rule.

5. The method as claimed in claim 3, comprising:
presenting the functions on a display or in a protocol together with the services and sequences assigned to them.

6. The method as claimed in claim 1, comprising:
a data module which stores and assesses the configuration rules.

7. The method as claimed in claim 1, comprising:
selecting and executing the functions of the computer system through a function editor.

8. The method as claimed in claim 2, comprising:
checking whether at least one of a function which has been selected and a running function currently being executed contravene a configuration rule.

9. The method as claimed in claim 3, comprising:
checking whether at least one of a function which has been selected and a running function currently being executed contravene a configuration rule.

10. The method as claimed in claim 4, comprising:
presenting the functions on a display or in a protocol together with the services and sequences assigned to them.

11. The method as claimed in claim 2, comprising:
storing and assessing the configuration rules in a data module.

12. The method as claimed in claim 3, comprising:
storing and assessing the configuration rules in a data module.

13. The method as claimed in claim 4, comprising:
storing and assessing the configuration rules in a data module.

14. The method as claimed in claim 5, comprising:
storing and assessing the configuration rules in a data module.

15. The method as claimed in claim 2, comprising:
selecting and executing the functions of the computer system through a function editor.

16. The method as claimed in claim 3, comprising:
selecting and executing the functions of the computer system through a function editor.

17. The method as claimed in claim 4, comprising:
selecting and executing the functions of the computer system through a function editor.

18. A system for installing and configuring a computer system, comprising:
a network of computers; and
an apparatus which includes a memory device and hardware, the memory device storing software which controls the hardware in such a manner that the hardware at least one of selects and executes functions for running on one or more of the computers in a sequence, and checks whether a function which has been at least one of selected and a running function currently being executed contravene a configuration rule.

19. A system as claimed in claim 18, wherein the hardware comprises a function editor and a dependency and constraint solver.

20. The system as claimed in claim 18, wherein the apparatus selects and executes the functions of the network of computers through a function editor.
